(19) United States
(12) Patent Application Publication
(10) Pub. No.: US 2008/0284563 A1
(43) Pub. Date: Nov. 20, 2008

(54) Vehicle Key System

(76) Inventor: Shi-En Wang, Sijhih City (TW)

Correspondence Address: Silicon Valley Patent Group LLP, 18805 Cox Avenue, Suite 220, Saratoga, CA, 95070, US

(21) Appl. No.: 11/748,484

(22) Filed: May 14, 2007

(51) Int. Cl. G06K 9/00; G06F 7/04; G08B 29/00

(52) U.S. Cl. 340/5.53; 340/5.52

(57) ABSTRACT

A vehicle key system is provided. The vehicle key system comprises a vehicle computer system for a vehicle and a monolithic key structure. The monolithic key structure comprises a key portion coupled to the vehicle and a body portion electrically coupled to the vehicle computer system. The body portion comprises an image capturing unit capturing a biological feature and an image transmitting unit electrically coupled to the image capturing unit for transmitting the captured biological feature to the vehicle computer system.

### FIELD OF THE INVENTION

The present invention relates to a vehicle key system, and more particularly to a vehicle key system capable of capturing an image and transmitting the same.

### BACKGROUND OF THE INVENTION

As the basic requirement of living quality is getting higher, the automobile electronics industry is now blooming correspondingly. However, the first problem to be encountered will be the safety issue for the automobiles. Up to the present, there exist several kinds of recognition methods and devices that apply in the automobile electronic field, such as an image recognition technique, a speech recognition technique and a fingerprint recognition technique, wherein the fingerprint recognition technique has the highest accuracy. Furthermore, the development of various kinds of the fingerprint recognition techniques has become mature, which makes the fingerprint recognition techniques turn out to be the most convenient and the hottest recognition ones in the automobile electronic field nowadays.

U.S. Pat. No. 6,710,700 disclosed a fingerprint recognition system that used in the credit-verification and safety-burglarproof for automobiles. The system could wirelessly transmit the captured fingerprint to the vehicle computer system for the subsequent manipulations and the application after acquiring a user's fingerprint through one or multiple portable fingerprint scanner. However, this kind of fingerprint recognition system combining the functions of the fingerprint recognition and the vehicle computer system might encounter the problems that the fingerprints during the wireless transmission might be captured by others.

TW publication No. M279551 disclosed a portable burglarproof recognizer. The recognizer should firstly insert into a receiving device within the automobile, followed by starting the automobile engine by the vehicle key to further start the vehicle circuit, so that the automobile electrifies with the portable burglarproof recognizer to start the fingerprint recognition system. This kind of portable burglarproof recognizer could avoid the fingerprint being captured, but it takes the complex operational procedures, which brings more conveniences to the drivers.

In order to overcome the drawbacks in the prior art, an improved vehicle key system is provided. The particular design in the present invention not only solves the problems described above, but also is easy to be implemented. Thus, the invention has the utility for the industry.

### SUMMARY OF THE INVENTION

In view of the issue of complicated operational procedures when the driver starts the vehicle in the conventional burglarproof devices, the present invention provides a vehicle key capable of capturing the fingerprints. Drivers only need to start the vehicle with a monolithic key structure of the present invention, and then the interior circuits of the vehicle will be started to drive the subsequent fingerprint recognition, whereby drivers do not worry about missing one of the respective vehicle key and fingerprint recognizer and the vehicle cannot be started. Moreover, the complicated operational procedures to start the vehicle will be simplified.

In accordance with one aspect of the present invention, a vehicle key is provided. The vehicle key comprises a first component and a second component. The first component is inserted into a key hole of a vehicle and a second component is connected to the first component. The second component further comprises an image capturing unit and an image transmitting unit. The image capturing unit captures a biological feature and the image transmitting unit electrically couples to the image capturing unit for transmitting the captured biological feature to the vehicle.

In accordance with a further aspect of the present invention, an input component is provided. The vehicle key system comprises a vehicle computer system for a vehicle and a monolithic key structure. The monolithic key structure comprises a key portion coupled to the vehicle and a body portion electrically coupled to the vehicle computer system. The body portion comprises an image capturing unit capturing a biological feature and an image transmitting unit electrically coupled to the image capturing unit for transmitting the captured biological feature to the vehicle computer system.

In accordance with another aspect of the present invention, a vehicle key is provided. The vehicle key comprises a first portion coupled to a key hole of a vehicle and a second portion connected to the first portion. The second portion comprises a feature manipulating device electrically coupled to the vehicle via the second portion for obtaining a biological feature and transmitting the biological feature to the vehicle.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1(a) is an interior structural diagram of the vehicle key system according to a first preferred embodiment of the present invention;

FIG. 1(b) is an appearance diagram of the vehicle key system according to a first preferred embodiment of the present invention;

FIG. 2(a) is an interior structural diagram of the vehicle key system according to a second preferred embodiment of the present invention;

FIG. 2(b) is an appearance diagram of the vehicle key system according to a second embodiment of the present invention;

FIG. 3(a) is an interior structural diagram of the vehicle key system according to a third preferred embodiment of the present invention;

FIG. 3(b) is an appearance diagram of the vehicle key system according to a third embodiment of the present invention;

FIG. 4 is an operational flowchart of the first mode 371; and

FIG. 5 is an operational flowchart of the second mode 372.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

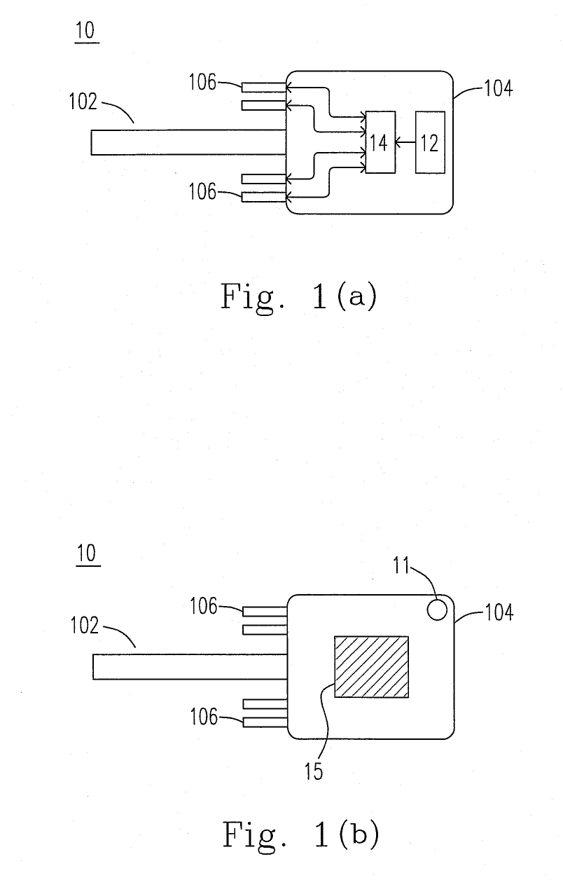

Please refer to FIG. 1(a), which depicts an interior structural diagram of the vehicle key system according to a first preferred embodiment of the present invention. The vehicle key system of the present invention comprises a vehicle key structure 10, an image capturing unit 12, an image transmitting image 14. The vehicle key structure 10 comprises a key portion 102 and a body portion 104, and the key portion 102 is further disposed a plurality of contact points 106. The image capturing unit 12 and the image transmitting unit 14 are disposed within the body portion 104 of the vehicle key structure 10, and the image transmitting unit 14 is electrically coupled to the image capturing unit 12. After the key portion 102 of the vehicle key structure 10 is inserted into a key hole disposed nearby the driver seat, the vehicle circuit system is started, and the power source further starts the image transmitting unit 12 through the plurality of contact points 106.

Please refer to FIG. 1(b), which depicts an appearance diagram of the vehicle key system according to a first preferred embodiment of the present invention. A fingerprint image pressed on a sensing area 15 of the body portion 104 will be captured after the image capturing unit 12 is started. Subsequently, the image transmitting unit 14 transmits the fingerprint image captured by the image capturing unit 12 to an interior computer system of the vehicle (not shown) through the plurality of contact points 106.

For the facilitation that the drivers could use the vehicle key system of the first preferred embodiment of the present invention, the exterior surface of the vehicle key structure 10 is further disposed a first indicator 11 to indicate whether the fingerprint image has been captured. The first indicator 11 is electrically coupled to the image capturing unit 12 and is one of a fluorescent light, a light emitting diode (LED) and an organic light emitting diode (OLED). The driver could know whether the fingerprint image has been captured by means of the ON/OFF of the first indicator 11 or the conversion of the different displaying colors.

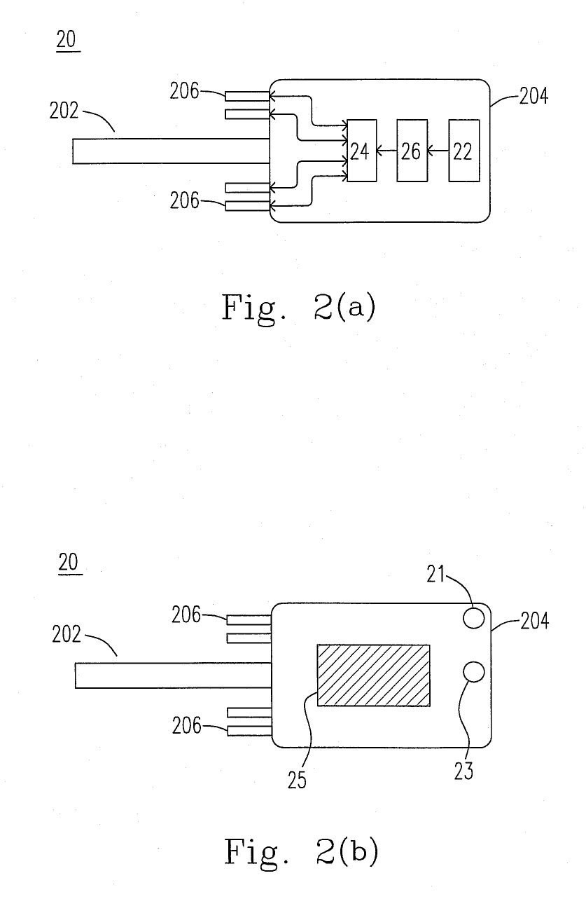

Please refer to FIG. 2(a), which depicts an interior structural diagram of the vehicle key system according to a second preferred embodiment of the present invention. The vehicle key system comprises a vehicle key structure 20, an image capturing unit 22, an image transmitting unit 24 and a memory 26. The vehicle key structure 20 comprises a key portion 202 and a body portion 204, and the key portion 202 is further disposed a plurality of contact points 206. The image capturing unit 22, the image transmitting unit 24 and the memory 26 are disposed within the body portion 204 of the vehicle key structure 20. Furthermore, the memory 26 is electrically coupled to the image capturing unit 26 and the image transmitting unit 24 is electrically coupled to the image capturing unit 22. The circuit system of the vehicle is started after the key portion 102 of the vehicle key structure 10 is inserted into a key hole disposed nearby the driver's seat, thereby starting the image capturing unit 22 through the plurality of contact points 206.

Please refer to FIG. 2(b), which depicts an appearance diagram of the vehicle key system according to a second embodiment of the present invention. A fingerprint image pressed on a sensing area 25 of the body portion 204 will be captured after the image capturing unit 22 is started. The captured fingerprint image is firstly stored in the memory 26. Moreover, the image transmitting unit 24 further comprises a command receiving subunit 242 (not shown). The command receiving subunit 242 receives the commands from the vehicle computer system. The image transmitting unit 24 transmits the fingerprint image stored in the memory to the vehicle computer system until the command receiving subunit 242 receives the commands from the vehicle computer system.

For the facilitation that the drivers could use the vehicle key system of the present invention, the exterior surface of the vehicle key structure 20 is further disposed a first indicator 21 and a second indicator 23. The first indicator 21 is electrically coupled to the image capturing unit 22, which is used to indicate whether the fingerprint image has been captured. The second indicator 23 is electrically coupled to the image transmitting unit 24, which is used to indicate whether the fingerprint image has been transmitted. The first indicator 21 and the second indicator 23 are one of a fluorescent light, a LED and an OLED. Whether the mentioned steps have been done could be indicated by means of the ON/OFF of the indicators or the conversion of the different displaying colors.

The difference between the vehicle key systems of the first and second embodiments is that the vehicle key system of the second embodiment could store the captured fingerprint image in the memory disposed within the vehicle key structure and then transmit the fingerprint image until the reception of the commands from the vehicle computer system. As to the vehicle key system of the first embodiment, the vehicle key structure directly transmits the fingerprint image to the vehicle computer system after capturing one fingerprint image.

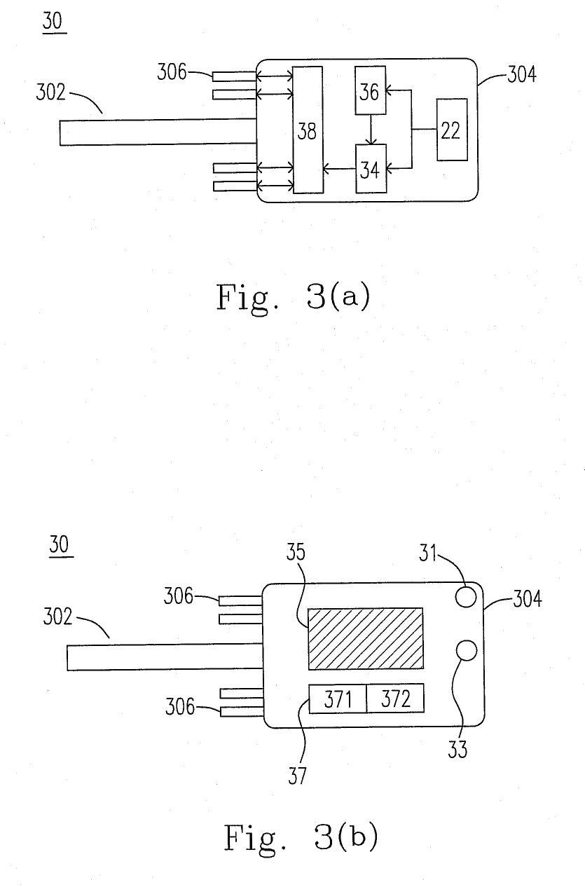

Please refer to FIG. 3(a), which depicts an interior structural diagram of the vehicle key system according to a third preferred embodiment of the present invention. The vehicle key system comprises a vehicle key structure 30, an image capturing unit 32, an image transmitting unit 34, a memory 36 and a regulating unit 38. The vehicle key structure 30 comprises a key portion 302 and a body portion 304, and the key portion 302 is further disposed a plurality of contact points 306. The image capturing unit 32, the image transmitting unit 34, the memory 26 and the regulating unit 38 are disposed within the body portion 304 of the vehicle key structure 30. Furthermore, the memory 36 is electrically coupled to the image capturing unit 32, and the image transmitting unit 34 is electrically coupled to the image capturing unit 32 and the memory 36. The regulating unit 38 is electrically coupled to the image transmitting unit 34.

Please refer to FIG. 3(b), which depicts an appearance diagram of the vehicle key system according to a third embodiment of the present invention. The vehicle key system of the third embodiment further integrates the advantages in the first and second embodiments. Accordingly, the exterior surface of the vehicle key structure 30 is further disposed a mode selection interface 37 that is electrically coupled to the regulating unit 38. The mode selection interface 37 provides two choices, a first mode 371 and a second mode 372, which could be selected depending on the driver's necessity to respond to the different situations.

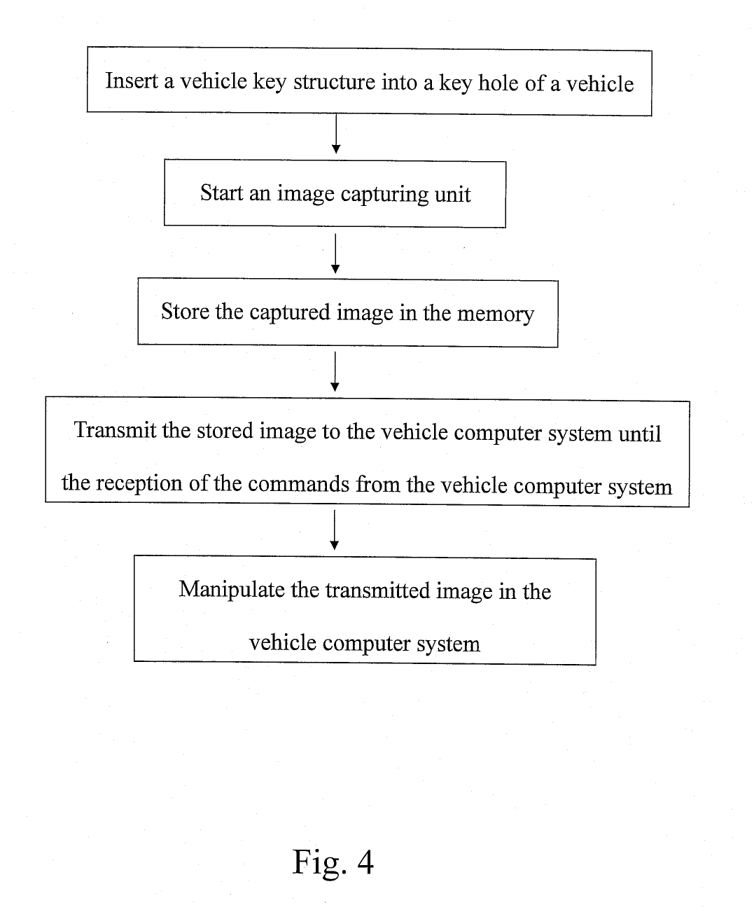

Please refer to FIG. 4, which depicts an operational flowchart of the first mode 371. In the first mode 371, the vehicle key structure 30 should be inserted into the key hole and then the vehicle power source starts the image capturing unit 32. The image capturing unit 32 starts to capture the fingerprint image to be stored in the memory 36. Until the command receiving subunit 242 receives the commands from the vehicle computer system, the image transmitting unit 34 starts to transmit the fingerprint image to the computer system. The fingerprint image transmitted to the computer system will undergo the subsequent manipulation and comparison.

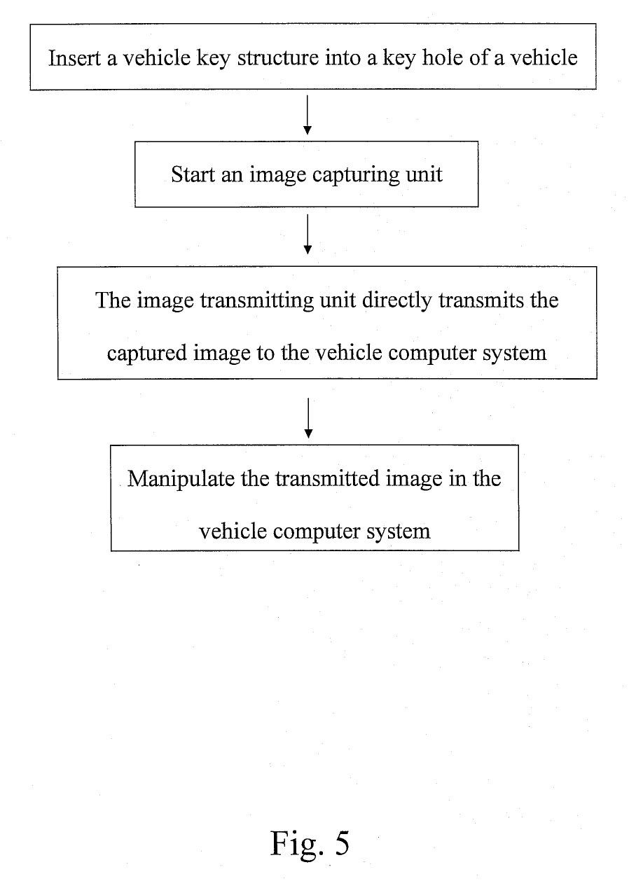

Please refer to FIG. 5, which depicts an operational flowchart of the second mode 372. In the second mode 372, the vehicle key structure 30 should be inserted into the key hole and then the vehicle power source starts the image capturing unit 32. Then, the image capturing unit 32 starts to capture the fingerprint image, followed by directly transmitting the captured fingerprint image to the vehicle computer system. Similarly, the fingerprint image transmitted to the computer system will undergo the subsequent manipulations and comparisons.

Also for the drivers could conveniently use the vehicle key system of the present invention, the vehicle key structure 30 is further disposed a first indicator 31 and a second indicator 33. The first indicator 31 is electrically coupled to the image capturing unit 32, which is used to indicate whether the fingerprint image has been captured. The second indicator 33 is electrically coupled to the image transmitting unit 34, which is used to indicate whether the fingerprint image has been transmitted. The first indicator 31 and the second indicator 33 are one of a fluorescent light, a LED and an OLED. Whether the mentioned steps have been done could be indicated by means of the ON/OFF of the indicators or the conversion of the different displaying colors.

Please refer to FIG. 3(a) again. Based on the mentioned, while drivers select the first mode 371, the regulating unit 38 will control the image transmitting unit 34 to be electrically coupled to the memory 36. Therefore, an image captured by the image capturing unit 32 from a sensing area 35 will be stored in the memory 36. Otherwise, while drivers select the second mode 372, the regulating unit 38 controls the image transmitting unit 34 to be electrically coupled to the image capturing unit 32. Then, the image transmitting unit 34 directly transmits the captured image to the vehicle computer system after the image capturing unit 32 captures the image. Furthermore, the communications between the vehicle key structure and the vehicle computer system are through the plurality of contact points 306 of the key portion 302.

In addition, the image capturing unit and the image transmitting unit could also be integrated into an image manipulation unit that electrically coupled to the vehicle.

Moreover, the subsequent comparison for the captured image could only include some recognizable biological features rather than the whole fingerprint image.

The image capturing units of the present invention could be one of a charge coupled device (CCD) and a complementary metal-oxide semiconductor (CMOS).

According to the vehicle key system of the present invention, drivers could firstly build up and store the fingerprint data in their vehicle computer system by means of the image capturing unit and the image transmitting unit of the vehicle key structure. Thereafter, while the image transmitting unit transmits the fingerprint image to the vehicle computer system, the computer system starts to analyze the transmitted fingerprint data. After the analysis, the vehicle computer system will further compare the fingerprint feature originally built up in their computer database. If the comparing features are matched, drivers could further proceed other steps to start the vehicle. If the comparing features are not matched, a burglarproof system of the vehicle will be started.

According to the vehicle key system of the present invention, drivers could further set up the specific users' authority after built up the fingerprint image database. If the fingerprint image transmitted from the vehicle key structure is not granted the authority, the driver fails to start the vehicle.

In conclusion, the present invention provides a vehicle key system that integrates the benefits of the fingerprint scanning technique with the small-volume and the traditional vehicle key and does not increase the original volume of the traditional vehicle key. Drivers use the vehicle key of the present invention to start the vehicle, and at the same time the fingerprint data of drivers is obtained and transmitted to the computer system for a further comparison. The comparison result could be applied in the against-burglary and the authority setting. Furthermore, the vehicle key system communicates with the vehicle computer system through the plurality of contact points of the key portion to transmit the fingerprint data, so that the transmission of the fingerprint image will not be captured by others in a wireless way.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A vehicle key, comprising:
a first component inserted into a key hole of a vehicle; and
a second component connected to the first component, comprising:
an image capturing unit capturing a biological feature; and
an image transmitting unit electrically coupled to the image capturing unit for transmitting the captured biological feature to the vehicle.

2. A vehicle key as claimed in claim 1, wherein the biological feature is a fingerprint, and the biological feature transmitted by the image transmitting unit is transmitted to a computer system of the vehicle.

3. A vehicle key as claimed in claim 1, wherein the first component further comprises a plurality of contact points, after the first component is inserted into the key hole, a power source is transmitted to the second component through the plurality of contact points, and the biological feature is transmitted to the computer system through the plurality of contact points.

4. A vehicle key as claimed in claim 1, wherein the second component further comprises an indicator indicating whether the biological feature is captured, and the indicator is one of a light emitting diode and an organic light emitting diode.

5. A vehicle key as claimed in claim 1, further comprising:
a memory electrically coupled to the respective image capturing unit and the image transmitting unit for storing the captured biological feature.

6. A vehicle key as claimed in claim 5, wherein the second component further comprises an indicator indicating whether the biological feature is transmitted, and the indicator is one of a light emitting diode and an organic light emitting diode.

7. A vehicle key as claimed in claim 5, wherein the image transmitting unit further comprises a command receiving subunit receiving a command from a computer system of the vehicle.

8. A vehicle key as claimed in claim 5, further comprising:
a regulating unit electrically coupled to the image transmitting unit for controlling whether the image transmitting unit transmits the biological feature.

9. A vehicle key as claimed in claim 8, wherein the second component further has a mode selection interface, wherein a user decides to directly transmit the biological feature to a computer system of the vehicle without storing the captured biological feature in the memory.

10. A vehicle key as claimed in claim 1, wherein the image capturing unit is one of a charge coupled device and a complementary metal-oxide semiconductor.

11. A vehicle key system, comprising:
a vehicle computer system for a vehicle; and
a monolithic key structure, comprising:
a key portion coupled to the vehicle; and
a body portion electrically coupled to the vehicle computer system, comprising:
an image capturing unit capturing a biological feature; and
an image transmitting unit electrically coupled to the image capturing unit for transmitting the captured biological feature to the vehicle computer system.

12. A vehicle key system as claimed in claim 11, wherein the biological feature is a fingerprint and the image capturing unit is one of a charge coupled device and a complementary metal-oxide semiconductor.

13. A vehicle key system as claimed in claim 11, wherein the key portion further comprises a plurality of contact points, after the key portion is inserted into a key hole of the vehicle, a power source is transmitted to the body portion through the plurality of contact points, and the biological feature is transmitted to the vehicle computer system through the plurality of contact points.

14. A vehicle key system as claimed in claim 11, wherein the body portion further comprises an indicator indicating whether the biological feature is captured, and the indicator is one of a light emitting diode and an organic light emitting diode.

15. A vehicle system as claimed in claim 11, wherein the body portion further comprising:
a memory electrically coupled to the respective capturing unit and the image transmitting unit for storing the captured biological feature.

16. A vehicle key system as claimed in claim 15, wherein the body portion further comprises an indicator indicating whether the biological feature is transmitted, and the indicator is one of a light emitting diode and an organic light emitting diode.

17. A vehicle key system as claimed in claim 15, wherein the image transmitting unit further comprises a command receiving subunit receiving a command from the vehicle computer system.

18. A vehicle key system as claimed in claim 15, wherein the body portion farther comprises:
a regulating unit electrically coupled to the image transmitting unit for controlling whether the image transmitting unit transmits the biological image to the vehicle computer system.

19. A vehicle key as claimed in claim 18, wherein the body portion further has a mode selection interface, wherein a user decides to directly transmit the biological feature to the vehicle computer system without storing the captured biological feature in the memory.

20. A vehicle key, comprising:
a first portion coupled to a key hole of a vehicle; and
a second portion connected to the first portion, comprising:
a feature manipulating device electrically coupled to the vehicle via the second portion for obtaining a biological feature and transmitting the biological feature to the vehicle.
